(19) United States
(12) Patent Application Publication
(10) Pub. No.: US 2026/0285478 A1
(43) Pub. Date: Sep. 24, 2026

(54) ZINC-NICKEL PLATING SYSTEM FOR LIGHTLY LOADED FRETTING APPLICATIONS

(71) Applicant: Goodrich Corporation, Charlotte, NC (US)

(72) Inventors: Alyssa Haas, London (CA); Edward Benedict Evans, Toronto (CA); Mirko Zdero, Dundas (CA); Noel C. Haynes, Etobicoke (CA)

(73) Assignee: Goodrich Corporation, Charlotte, NC (US)

(21) Appl. No.: 19/545,476

(22) Filed: Feb. 20, 2026

Related U.S. Application Data
(60) Provisional application No. 63/774,345, filed on Mar. 19, 2025.

(51) Int. Cl. B64C 25/36

(52) U.S. Cl. CPC B64C 25/36

(57) ABSTRACT

A Zinc-Nickel (ZnNi) plating system for increased fretting wear and corrosion resistance between components. The system includes first component and a mating component. A portion of the mating component is configured to interface with a portion of the first component. At least the portion of the first component or the portion of the mating component is plated with ZnNi for increased fretting wear and corrosion resistance between the portion of the first component and the portion of the mating component.

### CROSS-REFERENCE TO RELATED APPLICATIONS

This application claims priority to and the benefit of, U.S. Provisional Application No. 63/774,345, filed Mar. 19, 2025, and entitled “ZINC-NICKEL PLATING SYSTEM FOR LIGHTLY LOADED FRETTING APPLICATIONS,” which is incorporated by reference herein in its entirety for all purposes.

### FIELD

The present disclosure generally relates to the field of aircraft and, more particularly, to a use of a Zinc-Nickel (ZnNi) plating system for increased fretting wear and corrosion resistance between aircraft components.

### BACKGROUND

Current production of some aircraft components, e.g., axles, utilize two separate coating or plating systems on an inside diameter (ID) of one of the aircraft components that will contact an outside diameter (OD) of another aircraft component or vice versa. The two separate coating or plating systems are used due to a contact area between a portion of the axle and the in-axle equipment, which typically has a more robust corrosion protection system than the rest of the axle. The two separate coating or plating systems entail many operations, with long processing time, higher cost, and, typically, poorer first-pass yield.

### SUMMARY

A Zinc-Nickel (ZnNi) plating system for increased fretting wear and corrosion resistance between components is disclosed herein. The ZnNi plating system includes a first component and a mating component. In the ZnNi plating system, a portion of the mating component is configured to interface with a portion of the first component. In the ZnNi plating system, at least the portion of the first component or the portion of the mating component is plated with ZnNi to for increased fretting wear and corrosion resistance between the portion of the first component and the portion of the mating component.

In various embodiments, the first component is an aircraft axle.

In various embodiments, the portion of the first component is an inner circumference of at least one of a first end or a second send of the aircraft axle.

In various embodiments, the mating component is a wheel speed sensor with or without a brake fan.

In various embodiments, the portion of the mating component is an outer circumference of the wheel speed sensor with or without a brake fan.

In various embodiments, the first component is a bore.

In various embodiments, the portion of the first component is an inner circumference of the bore.

In various embodiments, the mating component is a bushing.

In various embodiments, the portion of the mating component is an outer circumference of the bushing.

In various embodiments, the mating component is formed from at least one of stainless steel or a copper alloy. In various embodiments, responsive to the first portion of the mating component and the second portion of the mating component being plated with ZnNi is in response to the mating component being formed from the alloy steel.

In various embodiments, the first component is a steering axle.

In various embodiments, the portion of the first component is an inner circumference of the steering axle bottle bore.

In various embodiments, the mating component is a coupling device.

In various embodiments, the portion of the mating component is an outer circumference of the coupling device.

In various embodiments, the ZnNi plating system further includes a second component. In various embodiments, the second component is a landing gear assembly. In various embodiments, the portion of the mating component is a first portion of the mating component. In various embodiments, the first portion of the mating component is configured to interface with the portion of the first component. In various embodiments, a second portion of the mating component is configured to interface with a portion of the second component. In various embodiments, at least the portion of the first component and the portion of the second component or the first portion of the mating component and the second portion of the mating component are plated with ZnNi for increased fretting wear and corrosion resistance between the portion of the first component and the first portion of the mating component and for increased fretting wear and corrosion resistance between the portion of the second component and the second portion of the mating component.

In various embodiments, the mating component is formed from alloy steel and wherein, the first portion of the mating component and the second portion of the mating component being plated with ZnNi is in response to the mating component being formed from the alloy steel and the portion of the first component and the portion of the second component being coated with a chrome or thermal spray coating.

In various embodiments, the portion of the first component, the portion of the second component, the first portion of the mating component, and the second portion of the mating component are plated with ZnNi.

In various embodiments, the first component and the second component are formed of an alloy steel.

In various embodiments, the mating component is formed from at least one of Aluminum or alloy steel and wherein the portion of the mating component being plated with ZnNi is in response to the mating component being formed from the alloy steel.

In various embodiments, both the portion of the first component and the portion of the mating component are plated with ZnNi.

Also disclosed herein is an aircraft. The aircraft includes a first component and a mating component. In the aircraft, a portion of the mating component is configured to interface with a portion of the first component. In the aircraft, at least the portion of the first component or the portion of the mating component is plated with ZnNi for increased fretting wear and corrosion resistance between the portion of the first component and the portion of the mating component.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft having left, right and nose landing gear assemblies and wheels mounted thereon, in accordance with various embodiments.

FIG. 2 illustrates an isometric view of an exemplary landing gear assembly, in accordance with various embodiments.

FIG. 3 illustrates a view of an aircraft axle, in accordance with various embodiments.

FIG. 4 illustrates a view of an aircraft landing gear shock strut, in accordance with various embodiments.

FIG. 5 illustrates a cross section of a portion of an aircraft landing gear shock strut, in accordance with various embodiments.

FIG. 6 illustrates a view of an aircraft aft steering bore, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Typically, Zinc-Nickel (ZnNi) plating is only used as corrosion protection when there is no contact expected between a portion of a first aircraft component plated with ZnNi and another aircraft component. In the various embodiments, described hereafter, ZnNi plating, which is typically used only for corrosion protection, is extended to fretting wear applications. ZnNi is a coating or plating system with an enhanced first-pass yield and reduced application time as compared to the typical coating system used in fretting applications. In various embodiments, the extension of ZnNi from only corrosion protection to corrosion protection in fretting wear applications provides for a substantial reduction in processing steps and improved turnaround time. Therefore, in current aircraft applications where enhanced barrier coatings (such as nickel or nickel chromium alloys, among others) are used in fretting wear applications, in the various embodiments, a zinc-nickel plating may be implemented. Although the below is described with regard to aircraft axles, the various embodiments are not limited to only axle applications. In that regard, in various embodiments, the described ZnNi plating system, which may also be referred to a ZnNi coating system, is applied at any location within an aircraft where there is anticipated fretting or opportunity for fretting between a ZnNi plated portion of a first component and a portion of a second, mating component, such as in landing gear or axle steering bore, among others. In various embodiments, the second mating component also includes a ZnNi plated portion that interfaces with the ZnNi plated portion of a first component. In various embodiments, the “zinc-nickel” or “zinc-nickel plating system” or “zinc-nickel coating system” may include zinc-nickel (ZnNi) with or without primer and/or paint. In various embodiments, the “zinc-nickel” or “zinc-nickel plating system” or “zinc-nickel coating system” may include zinc-nickel (ZnNi) with or without chromate treatment. In various embodiments, the “zinc-nickel” or “zinc-nickel plating system” or “zinc-nickel coating system” may include zinc-nickel (ZnNi) with or without primer and/or paint and with or without chromate treatment.

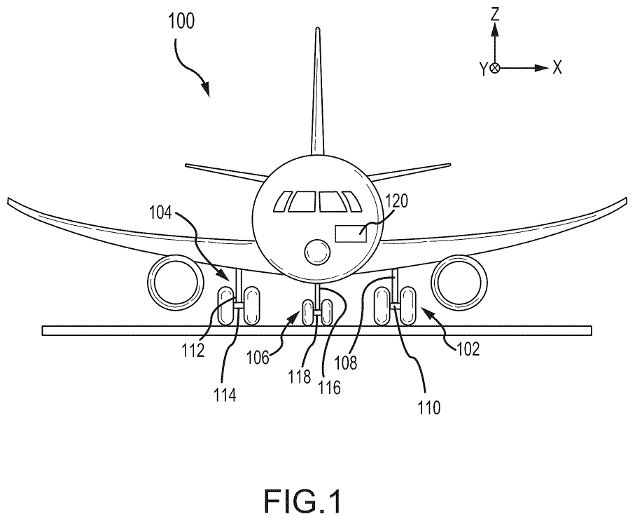

Referring now to FIG. 1, an aircraft 100 is illustrated, in accordance with various embodiments. In accordance with various embodiments, aircraft 100 includes one or more landing gear assemblies, such as, for example, a left landing gear assembly 102 (or port-side landing gear assembly), a right landing gear assembly 104 (or starboard-side landing gear assembly) and a nose landing gear assembly 106. Each of left landing gear assembly 102, right landing gear assembly 104, and nose landing gear assembly 106 supports the aircraft 100 when not flying, allowing aircraft 100 to taxi, takeoff, and land safely and without damage to aircraft 100. In various embodiments, left landing gear assembly 102 includes a left shock strut assembly 108 and a left wheel assembly 110, right landing gear assembly 104 includes a right shock strut assembly 112 and a right wheel assembly 114, and nose landing gear assembly 106 includes a nose shock strut assembly 116 and a nose wheel assembly 118.

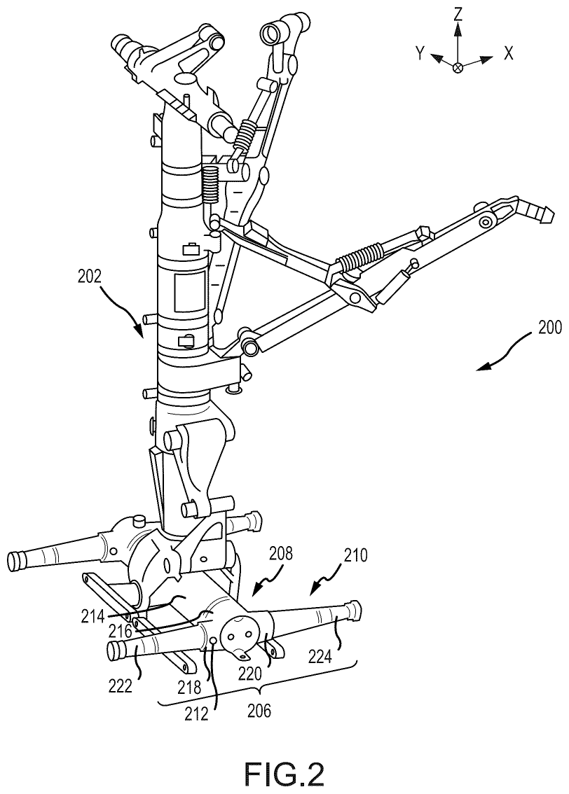

Referring now to FIG. 2, a landing gear 200, such as nose landing gear assembly 106, left wheel assembly 110, or right landing gear assembly 104 of FIG. 1, is illustrated, in accordance with various embodiments. As depicted in FIG. 2, the landing gear 200 for the aircraft, such as aircraft 100 of FIG. 1, generally comprises a shock strut assembly 202 coupled to a bogie beam assembly 206. The bogie beam assembly 206, according to various embodiments, generally comprises a bogie beam 208, an axle 210 for carrying wheels, and at least one retention bolt 212 for directly coupling the axle 210 to the bogie beam 208. FIG. 2 depicts a single retention bolt. It is to be understood that the number of retention bolts may vary from other than depicted and additional retention bolts may be used. The at least one retention bolt 212 is secured by a nut or the like.

The bogie beam 208 comprises an elongated main body portion 214 having an end portion 216 disposed between a forward sleeve portion 218 and an opposing aft sleeve portion 220 that are transverse to the elongated main body portion 214. The bogie beam 208, according to various embodiments, is generally I-shaped. The forward sleeve portion 218 and the opposing aft sleeve portion 220 each include a bore for receiving the axle 210 as hereinafter described.

The axle 210 extends through the forward sleeve portion 218, the end portion 216, and the opposing aft sleeve portion 220. The axle 210 is configured for carrying at least one pair of wheels of the landing gear 200. The axle 210 extends beyond the forward sleeve portion 218 to define an exposed forward axle portion 222 and beyond the opposing aft sleeve portion 220 to define an exposed aft axle portion 224. An inner surface of the forward sleeve portion 218 and the opposing aft sleeve portion 220 directly contact an outer surface of the axle 210. At least one retention bolt 212 is depicted in FIG. 1 as being secured through the forward sleeve portion 218 and the axle 210.

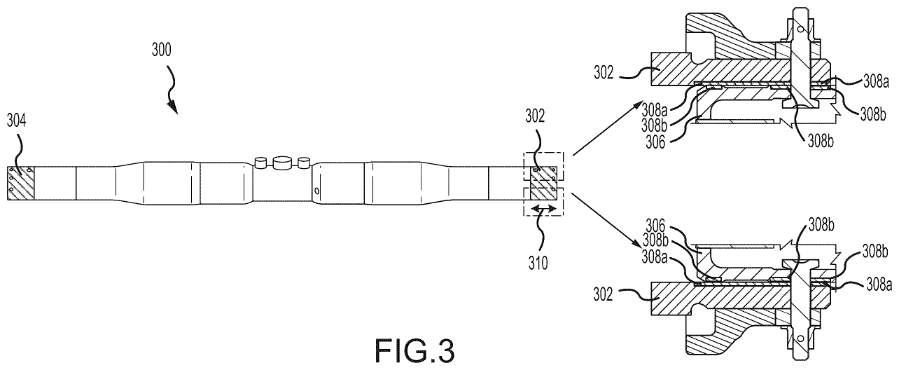

Referring now to FIG. 3, a view of an aircraft axle is illustrated, in accordance with various embodiments. In various embodiments, a first component 300, i.e. the axle, includes a first end 302 and a second end 304 opposite the first end 302. In various embodiments, both the first end 302 and the second end 304 are configured to interface with a mating component 306, which is pinned within the second end 304 and/or the first end 302, as illustrated, and thus in direct contact or with a slight gap, allowing for fretting wear during regular use. In various embodiments, the mating component 306 may be wheel speed sensor with or without a brake fan. In various embodiments, the interface may be an interference fit or a gap that allows fretting during regular service.

In various embodiments, the substrate of the first end 302 and the second end 304 are formed from an alloy steel, such as 300M/4340 MOD/Aermet steel/4340, with exceptionally good fatigue strength, ductility, impact strength, and fracture toughness. In various embodiments, 300M is a chrome nickel molybdenum alloy, and may include one or more of vanadium, silicon, carbon, chromium, manganese, and molybdenum with balance of iron. In various embodiments, 300M is also known as 4340 MOD.

In order to increase fretting wear and corrosion resistance, in various embodiments, the inner circumference of the first end 302 and the second end 304 of the first component 300 is plated or coated with a ZnNi plating system 308a. In that regard, in various embodiments, the ZnNi plating system 308a extends for a distance 310 from the end of the first end 302 and the second end 304 of the first component 300. The distance 310 may coincide with the interface with the mating component 306.

In various embodiments, the mating component 306 may be formed from Aluminum (Al), Al alloys (e.g., 6000 series or 7000 series aluminum alloy), or an alloy steel. In various embodiments, responsive to the mating component 306 being formed from an aluminum alloy, the mating component 306 may or may not have surface treatments including anodizing. In various embodiments, responsive to the mating component 306 being formed from the alloy steel, then the outer circumference of mating component 306 of the first component 300 may be plated or coated with a ZnNi plating system 308b.

In various embodiments, the ZnNi plating system 308a and the ZnNi plating system 308b may have a thickness of between 0.0002 inch (0.000508 centimeter) and 0.002 inch (0.00508 centimeter) . In various embodiments, ZnNi has a Vickers hardness rating ranging between 350 HV and 500 HV.

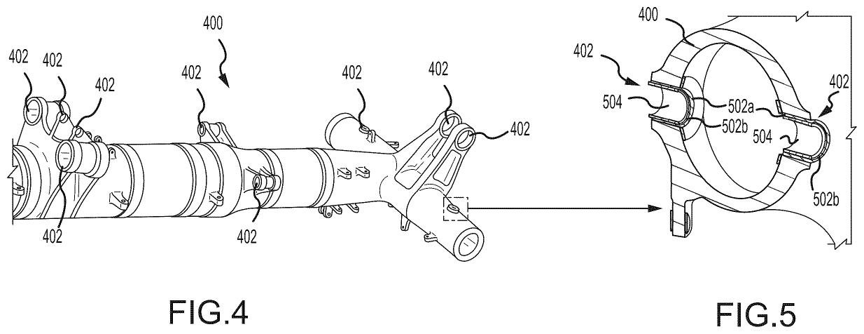

Referring now to FIGS. 4 and 5, a view of an aircraft landing gear shock strut and a cross section of a portion of the aircraft landing gear shock strut is illustrated, in accordance with various embodiments. In various embodiments, the landing gear shock strut 400 includes a first component 402, i.e. one or more bores, into which mating component 504, as described hereafter in FIG. 5, i.e., a bushing, is fitted. In various embodiments, a further component is fitted into the mating component 504 and the mating component 504 may rotate or migrate within an associated bore of the first component 402, which may cause fretting.

In various embodiments, the substrate of the first component 402 is an alloy steel, such as 300M/4340 MOD/Aermet steel/4340, with exceptionally good fatigue strength, ductility, impact strength, and fracture toughness. In various embodiments, 300M is a chrome nickel molybdenum alloy, and may include one or more of vanadium, silicon, carbon, chromium, manganese, and molybdenum with balance of iron. In various embodiments, 300M is also known as 4340 MOD.

In order to increase fretting wear and corrosion resistance, in various embodiments, as is illustrated in FIG. 5, the inner circumference of the first component 402 of the landing gear shock strut 400 may be plated or coated with a ZnNi plating system 502a. In that regard, in various embodiments, the ZnNi plating system 502a extends a length of a bore of the first component 402 from the inner circumference of the landing gear shock strut 400 to the outer circumference of the landing gear shock strut 400. Accordingly, in various embodiments, the ZnNi plating system extends at least through the entire bore length 402 and all mating regions associated with mating component 504.

In various embodiments, the mating component 504, i.e. the bushing, may be formed from a stainless steel (such as 15-5 PH) or a copper alloy (such as aluminum-nickel-bronze). In various embodiments, the outer circumference of the mating component 504 may also be plated or coated with a ZnNi plating system 502b.

In various embodiments, the ZnNi plating system 502a and the ZnNi plating system 502 b may have a thickness of between 0.0002 inch (0.000508 centimeter) and 0.002 inch (0.00508 centimeter). In various embodiments, ZnNi has a Vickers hardness rating ranging between 350 HV and 500 HV.

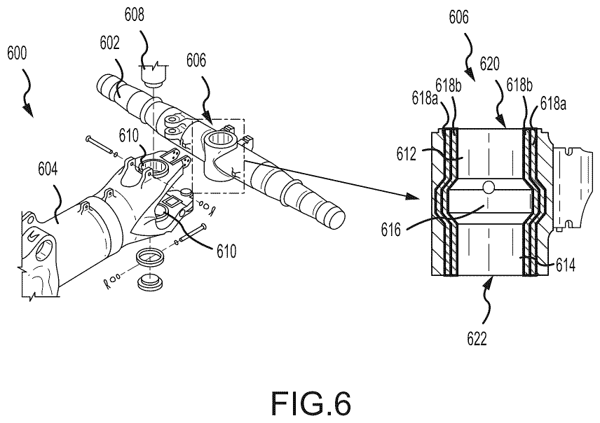

Referring now to FIG. 6, a view of an aircraft aft steering bore is illustrated, in accordance with various embodiments. In various embodiments, the aircraft steering assembly 600 may include a first component 602, i.e., a steering axle, and a second component 604, i.e., a landing gear assembly, into which the first component 602 is coupled. In various embodiments, the first component 602 includes a steering bore 606 and the second component 604 includes a set of openings 610. In various embodiments, once the first component is fitted into the second component 604, the steering bore 606 and the set of openings 610 receive a mating component 608, i.e., a coupling device. In various embodiments, the mating component 608 passes through the set of openings 610 in the second component 604 prior to and after passing through the steering bore 606. Additionally, in various embodiments, the mating component 608 may be fixedly coupled to the second component 604 and thus, the inside surface of the steering bore 606 of the first component 602 rotates about the mating component 608, which may cause fretting.

In various embodiments, a substrate of the steering bore 606 may be an alloy steel, such as 300M/4340 MOD/Aermet steel/4340, with exceptionally good fatigue strength, ductility, impact strength, and fracture toughness. In various embodiments, 300M is a chrome nickel molybdenum alloy, and may include one or more of vanadium, silicon, carbon, chromium, manganese, and molybdenum with balance of iron. In various embodiments, 300M is also known as 4340 MOD.

In various embodiments, the steering bore 606 may include an upper bushing bore 612, a lower bushing bore 614, and a bottle bore 616. In various embodiments, the inner circumferences of the upper bushing bore 612, the lower bushing bore 614, and the bottle bore 616 may be plated or coated with a ZnNi plating system 618a. In that regard, in various embodiments, the ZnNi plating system 618a may extend a length of the steering bore 606 from a top surface 620 of the first component 602 to the bottom surface 622 of the first component 602. In various embodiments, the inner circumferences of the set of openings 610 may be plated or coated with chrome or thermal spray coating or a ZnNi plating system 618a. In that regard, in various embodiments, the ZnNi plating system 618a may extend a length of the set of openings 610.

In various embodiments, the mating component 608 may be formed from an alloy steel. In various embodiments, responsive to the mating component 608 being formed from the alloy steel, then the outer circumference of the mating component 608 may also be plated or coated with chrome or thermal spray coating or a ZnNi plating system 618b. It is noted that, responsive to the inner circumferences of the set of openings 610 being plated or coated with chrome or thermal spray coating, then the outer circumference of the mating component 608 is plated or coated with the ZnNi plating system 618b, or vice versa.

In various embodiments, the ZnNi plating system 618a and the ZnNi plating system 618 b may have a thickness of between 0.0002 inch (0.000508 centimeter) and 0.002 inch (0.00508 centimeter). In various embodiments, ZnNi has a Vickers hardness rating ranging between 350 HV and 500 HV.

Accordingly, in various embodiments, an extension of ZnNi from only corrosion protection to corrosion protection in fretting wear applications provides a substantial reduction in processing steps and improved turnaround time of aircraft parts. ZnNi as a replacement to harder coatings used for fretting wear applications can improve first-pass yield and has shorter application time.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A Zinc-Nickel (ZnNi) plating system for increased fretting wear and corrosion resistance between components, comprising:
a first component; and
a mating component,
wherein a portion of the mating component is configured to interface with a portion of the first component, and
wherein at least the portion of the first component or the portion of the mating component is plated with ZnNi for increased fretting wear and corrosion resistance between the portion of the first component and the portion of the mating component.

2. The ZnNi plating system of claim 1, wherein the first component is an aircraft axle.

3. The ZnNi plating system of claim 2, wherein the portion of the first component is an inner circumference of at least one of a first end or a second end of the aircraft axle.

4. The ZnNi plating system of claim 2, wherein the mating component is a wheel speed sensor with or without a brake fan.

5. The ZnNi plating system of claim 4, wherein the portion of the mating component is an outer circumference of the wheel speed sensor with or without a brake fan.

6. The ZnNi plating system of claim 1, wherein the first component is a bore.

7. The ZnNi plating system of claim 6, wherein the portion of the first component is an inner circumference of the bore.

8. The ZnNi plating system of claim 6, wherein the mating component is a bushing.

9. The ZnNi plating system of claim 8, wherein the portion of the mating component is an outer circumference of the bushing.

10. The ZnNi plating system of claim 8, wherein the mating component is formed from at least one of stainless steel or a copper alloy.

11. The ZnNi plating system of claim 1, wherein the first component is a steering axle.

12. The ZnNi plating system of claim 11, wherein the portion of the first component is an inner circumference of the steering axle bottle bore.

13. The ZnNi plating system of claim 11, wherein the mating component is a coupling device.

14. The ZnNi plating system of claim 13, wherein the portion of the mating component is an outer circumference of the coupling device.

15. The ZnNi plating system of claim 11, further comprising:
a second component,
wherein the second component is a landing gear assembly,
wherein the portion of the mating component is a first portion of the mating component,
wherein the first portion of the mating component is configured to interface with the portion of the first component,
wherein a second portion of the mating component is configured to interface with a portion of the second component, and
wherein at least the portion of the first component and the portion of the second component or the first portion of the mating component and the second portion of the mating component are plated with ZnNi for increased fretting wear and corrosion resistance between the portion of the first component and the first portion of the mating component and for increased fretting wear and corrosion resistance between the portion of the second component and the second portion of the mating component.

16. The ZnNi plating system of claim 14, wherein the mating component is formed from alloy steel and wherein, the first portion of the mating component and the second portion of the mating component being plated with ZnNi is in response to the mating component being formed from the alloy steel and the portion of the first component and the portion of the second component being coated with a chrome or thermal spray coating.

17. The ZnNi plating system of claim 16, wherein the portion of the first component, the portion of the second component, the first portion of the mating component, and the second portion of the mating component are plated with ZnNi.

18. The ZnNi plating system of claim 15, wherein the first component and the second component are formed of an alloy steel.

19. The ZnNi plating system of claim 1, wherein both the portion of the first component and the portion of the mating component are plated with ZnNi.

20. An aircraft comprising:
a first component; and
a mating component,
wherein a portion of the mating component is configured to interface with a portion of the first component, and
wherein at least the portion of the first component or the portion of the mating component is plated with ZnNi for increased fretting wear and corrosion resistance between the portion of the first component and the portion of the mating component.
